(19) United States
(12) Patent Application Publication
(10) Pub. No.: US 2009/0015401 A1
(43) Pub. Date: Jan. 15, 2009

(54) VEHICLE LOCATION METHOD AND SYSTEM

(76) Inventor: Mark Joseph Hamzy, Round Rock, TX (US)

Correspondence Address: IBM CORP (YA);C/O YEE & ASSOCIATES PC, P.O. BOX 802333, DALLAS, TX, 75380, US

(21) Appl. No.: 11/776,741

(22) Filed: Jul. 12, 2007

(51) Int. Cl. G08B 1/08

(52) U.S. Cl. 340/539.32

(57) ABSTRACT

Method and system for locating a parked vehicle. A method for locating a parked vehicle includes receiving a vehicle arming signal at a vehicle arming signal receiving unit. The received vehicle arming signal is broadcast throughout a parking area in which a vehicle associated with the vehicle arming signal is parked. An arming acknowledgement signal provided by the vehicle associated with the vehicle arming signal is detected, and a location of the vehicle associated with the vehicle arming signal is identified using the arming acknowledgement signal.

### BACKGROUND OF THE INVENTION

1. Field of the Invention

The present invention relates generally to a vehicle location method and system, and more particularly, to a method and system for locating a parked vehicle in a large parking area.

2. Description of the Related Art

Shopping centers and other businesses often provide large parking areas for customers, employees and other individuals. Not infrequently, individuals forget where they parked their vehicle, and must walk around the parking area or find someone to drive them around the parking area to look for their vehicle. This can result in substantial inconvenience and some embarrassment to the individual.

Many vehicles are equipped with a wireless vehicle entry device or “wireless key” that an individual can use to lock or unlock a vehicle from a distance. Usually, locking the vehicle with a wireless vehicle entry device also causes the vehicle's headlights to flash on and off briefly and/or actuates the vehicle horn for a short period of time to acknowledge to the individual that the vehicle has been locked. These acknowledgement signals are sometimes used by an individual to help locate a vehicle. Wireless vehicle entry devices, however, have only a limited range, for example, 50-100 feet, and, therefore, are only effective in locating a vehicle when the individual is very close to the vehicle. Thus, the individual is usually still required to walk or otherwise move around the parking area in order to locate the vehicle.

There is, accordingly, a need for a mechanism that will enable an individual to quickly locate a parked vehicle in a large parking area without it being necessary for the individual to walk or otherwise move around the parking area looking for the vehicle.

Exemplary embodiments provide a method and system for locating a parked vehicle. A method for locating a parked vehicle according to an exemplary embodiment includes receiving a vehicle arming signal at a vehicle arming signal receiving unit. The received vehicle arming signal is broadcast throughout a parking area in which a vehicle associated with the vehicle arming signal is parked. An arming acknowledgement signal provided by the vehicle associated with the vehicle arming signal is detected, and a location of the vehicle associated with the vehicle arming signal is identified using the arming acknowledgement signal.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic view, looking down from above, of a facility surrounded by a large parking area to assist in explaining exemplary embodiments;

FIG. 2 is a schematic view, looking down from above, of a facility surrounded by a large parking area and including a vehicle location system according to an exemplary embodiment;

FIG. 3 illustrates a wireless vehicle entry device to assist in explaining exemplary embodiments;

FIG. 4 is a block diagram that illustrates a vehicle location system according to an exemplary embodiment; and

FIG. 5 is a flowchart that illustrates a method for locating a parked vehicle according to an exemplary embodiment.

### DETAILED DESCRIPTION OF THE PREFERRED EMBODIMENT

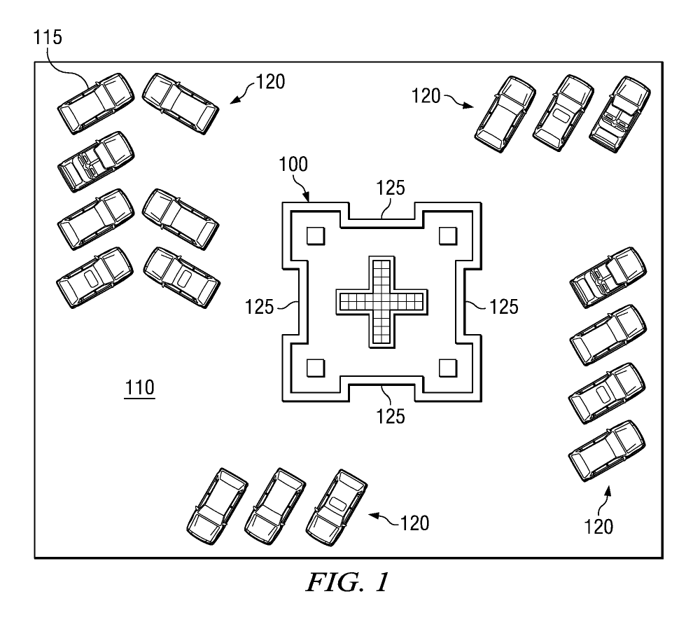

FIG. 1 is a schematic view, looking down from above, of a facility surrounded by a large parking area to assist in explaining exemplary embodiments. The facility is generally designated by reference number 100, and may be a shopping center, office building, amusement park or any other facility that typically serves a large number of people. As shown in FIG. 1, facility 100 is surrounded by parking area 110 for use by customers, employees or other persons to park their vehicles when they are visiting the facility.

Many facilities provide parking areas that can accommodate hundreds or even thousands of vehicles. In such a circumstance, it is not uncommon that individuals visiting the facility forget where they parked their vehicle. FIG. 1 illustrates a vehicle 115 that has been parked at a location in parking area 110 that is relatively distant from facility 100. Vehicle 115 may be surrounded by many other parked vehicles, generally designated by reference number 120, a few of which are shown in FIG. 1, such that vehicle 115 may not be readily visible from facility 100. Furthermore, facility 100 may have several entrances 125 that face in different directions, and the individual may not remember which entrance he or she used when entering the facility, and, thus, not even know which direction to go to find his or her vehicle.

Currently, when an individual forgets the location of his/her vehicle, the individual must either walk around the parking area searching for the vehicle, or seek assistance from a facility employee or the like to drive around the parking area to locate the vehicle. This can be time consuming and inconvenient, and embarrassing as well.

In accordance with exemplary embodiments, a method and system is provided to assist an individual in locating a parked vehicle. Exemplary embodiments recognize that many vehicles are equipped with a wireless vehicle entry device or “wireless key” that can be used to remotely lock and unlock the doors of a vehicle and to perform other functions. Usually, when a wireless vehicle entry device is used to lock the doors of a vehicle, the headlights of the vehicle are caused to flash on and off a few times and/or the vehicle horn may be caused to operate briefly to signal that the vehicle has been locked.

Individuals sometimes use the flashing headlights and/or the horn operation, both of which are referred to herein as an “arming acknowledgement signal”, to assist in locating their vehicle. The range of wireless vehicle entry devices, however, is quite limited, and is thus not very useful in locating a vehicle in a large parking area such as parking area 110 in FIG. 1. The individual would still have to walk or be driven around the parking area in order to locate his/her vehicle.

In accordance with exemplary embodiments, a wireless vehicle entry device is used to assist an individual in locating his/her vehicle without it being necessary for the individual to move around a parking area in which the vehicle is parked. According to an exemplary embodiment, a vehicle location system is provided that includes a vehicle location station having a vehicle arming signal receiving unit for receiving a vehicle arming signal from a wireless vehicle entry device. The vehicle location station may be located, for example, adjacent to a facility such as facility 100 in FIG. 1 or at some other convenient location. A broadcast unit of the vehicle location system then broadcasts the received vehicle arming signal throughout a parking area, such as parking area 110 in FIG. 1. When a vehicle associated with the wireless vehicle entry device detects the broadcast signal, the vehicle will provide an arming acknowledgement signal, for example, flashing headlights and/or a blast from the vehicle horn. The arming acknowledgement signal is detected by one or more arming acknowledgement signal detecting units of the vehicle location system and the location of the vehicle associated with the wireless vehicle entry device is computed using the detected arming acknowledgement signal. The location of the vehicle associated with the wireless vehicle entry device is then identified to the individual at the vehicle location station so that the individual may proceed directly to the vehicle.

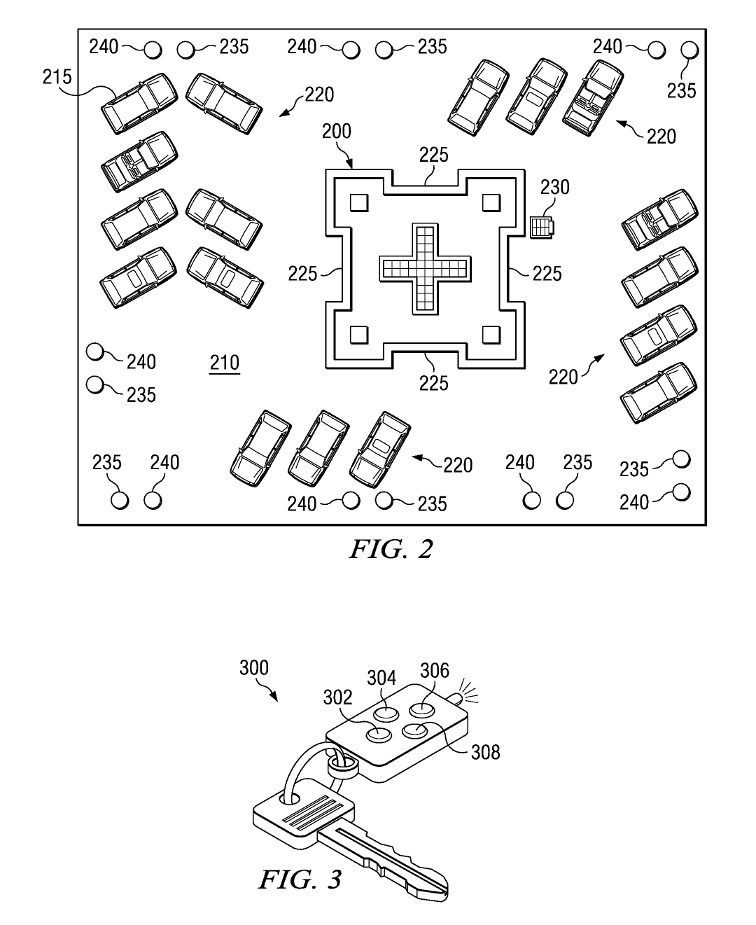

FIG. 2 is a schematic view, looking down from above, of a facility surrounded by a large parking area and including a vehicle location system according to an exemplary embodiment. Similar to FIG. 1, FIG. 2 illustrates facility 200 surrounded by parking area 210. Also similar to FIG. 1, FIG. 2 illustrates a vehicle 215 to be located which may be surrounded by many other parked vehicles, generally designated by reference number 220.

FIG. 2 also illustrates vehicle location station 230 at which an individual may locate a vehicle. In FIG. 2, vehicle location station is shown as being near one of entrances 225 of facility 200, for example, in a kiosk provided adjacent the entrance. It should be understood, however, that this is intended to be exemplary only, as vehicle location station may be inside facility 200, within parking area 210 or at any other convenient location. It should also be understood that although only one vehicle location station is shown in FIG. 2, a plurality of vehicle location stations may be provided at different locations, if desired.

FIG. 2 also illustrates a plurality of vehicle arming signal retransmission units 235 and a plurality of arming acknowledgement signal detecting units 240 positioned at a plurality of locations around parking area 210. Each vehicle arming signal retransmission unit 235 receives a vehicle arming signal transmitted from vehicle location station 230 and retransmits the signal so that it may be “heard” by vehicles in its vicinity. Each arming acknowledgement signal detecting unit 240 may include a sound detecting unit such as a microphone, and/or an image detecting unit such as a camera. Each arming acknowledgement signal detecting unit 240 is positioned to monitor a portion or section of parking area 210 and the number of detecting units is preferably sufficient to enable monitoring of the entire parking area 210. Detecting units 240 may, for example, be mounted on poles so that the image detecting units thereof, in particular, can view the headlights of all the vehicles parked in their respective sections of parking area 210. The detecting units can be stationary, or they can be mounted so as to be able to scan their respective sections, and the detecting units are preferably sufficient in number and positioned such that an arming acknowledgement signal provided by a vehicle can be detected by two or more detecting units to facilitate computing of the location of the vehicle providing the arming acknowledgement signal, for example, by triangulation. The retransmission units and the arming acknowledgement signal detecting units can be mounted together or they can be provided at different locations.

FIG. 3 schematically illustrates a wireless vehicle entry device to assist in explaining exemplary embodiments. The wireless vehicle entry device is generally designated by reference number 300, and includes a lock button 302 for use in locking the doors of a vehicle, and an unlock button 304 for unlocking the vehicle doors. Device 300 may also include a button 306 for unlocking the trunk of the vehicle, and an alarm button 308 for use in an emergency. Wireless vehicle entry device 300 may be a separate component mounted on a key ring as shown in FIG. 3, or it may be built into a vehicle key.

Typically, when lock button 302 is pressed to lock the doors of a vehicle, an RF arming signal is generated by wireless vehicle entry device 300 which is detected at the vehicle associated with the device, for example, vehicle 215 in FIG. 2, to cause the vehicle doors to be locked and, at the same time, to cause the vehicle headlights to briefly flash and/or the horn to briefly operate to serve as a signal to acknowledge to the individual operating the wireless vehicle entry device that the vehicle has been locked. Exemplary embodiments utilize this “arming acknowledgement signal” to locate a vehicle for an individual who may have forgotten where he/she parked the vehicle.

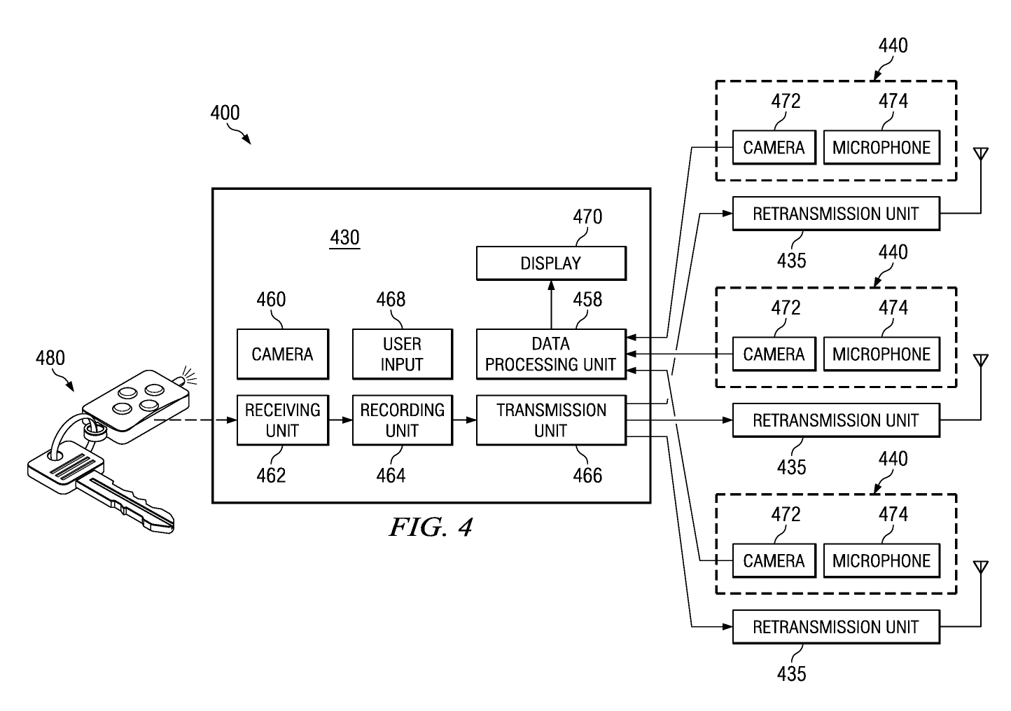

FIG. 4 is a block diagram that schematically illustrates a vehicle location system according to an exemplary embodiment. The system is generally designated by reference number 400, and includes vehicle location station 430, a plurality of vehicle arming signal retransmission units 435 and a plurality of arming acknowledgement signal detecting units 440. Vehicle location station 430 can be implemented as vehicle location station 230 in FIG. 2, and vehicle arming signal retransmission units 435 and arming acknowledgement signal detecting units 440 can be implemented as arming signal retransmission units 235 and arming acknowledgement signal detecting units 240 in FIG. 2.

Vehicle location station 430 includes vehicle arming signal receiving unit 462, recording unit 464, vehicle arming signal transmission unit 466, user input 468, display 470 and data processing unit 458. Vehicle arming signal receiving unit 462 comprises, for example, an RF detector sensitive to RF signals generated by wireless vehicle entry devices. Vehicle arming signal receiving unit 462 is adapted to receive an RF vehicle arming signal generated by a wireless vehicle entry device such as wireless vehicle entry device 480 when an individual presses the lock button on the device in the vicinity of vehicle arming signal receiving unit 462.

Recording unit 464 records the vehicle arming signal received by receiving unit 462 so that the signal is available to be replayed, if necessary, as will be explained hereinafter. Transmission unit 466 receives the vehicle arming signal recorded by recording unit 464 and transmits the signal to the plurality of vehicle arming signal retransmission units 435 distributed around a parking area, such as parking area 210 in FIG. 2.

Vehicle arming signal retransmission units 435, in turn, broadcast the vehicle arming signal throughout the parking area. Vehicle arming signal transmission unit 466 at vehicle location station 430 and the plurality of vehicle arming signal retransmission units 435 together comprise a “broadcast unit” for broadcasting a vehicle arming signal throughout a parking area such as parking area 210 in FIG. 2.

Arming acknowledgement signal detecting units 440 are positioned at a plurality of locations throughout a parking area, such as parking area 210 in FIG. 2, so as to provide coverage of the entire parking area. Each arming acknowledgement signal detecting unit includes an image arming acknowledgement signal detecting unit such as camera 472 and/or a sound arming acknowledgement signal detecting unit such as a microphone 474.

When an individual/user that has parked his/her vehicle in a parking area of a facility wishes assistance in locating the vehicle, the user will first go to vehicle location station 430. At vehicle location station 430, the user will operate user input 468, which may, for example, be a “start” button, to initiate a vehicle locating operation. The user is then instructed, via display 470 to hold his/her wireless vehicle entry device near receiving unit 462 and to depress the lock button on the device. The user may also be warned, via the display, not to press the unlock button on the device so as to not unlock the vehicle that the user is attempting to locate. The RF vehicle arming signal generated by the wireless vehicle entry device will be received by receiving unit 462 and recorded by recording unit 464. The recorded signal is then transmitted to retransmission units 435 by transmission unit 466 so as to be broadcast throughout a parking area in which the vehicle being searched for is located.

When the broadcast vehicle arming signal is detected at the user's vehicle, the headlights on the vehicle will be caused to flash and/or the vehicle horn will be caused to operate briefly to provide an arming acknowledgement signal. One or more of arming acknowledgement signal detecting units 440 positioned throughout the parking area will detect the arming acknowledgement signal provided by the vehicle and forward the detected signals to data processing unit 458 (which may be located at vehicle location station 430 as shown in FIG. 4 or be at a different location). Data processing unit 458 computes the location of the vehicle that provided the arming acknowledgement signal in the parking area, for example, using a triangulation algorithm or in another manner, and the location of the vehicle is identified to the user via display 470.

Display 470 can, for example, display a map of the parking area and mark the location of the user's vehicle on the map. Alternatively, the display can provide the user with directions to the vehicle such as by identifying the section, row and space location of the vehicle.

It may occur that one or more other individuals were in the process of locking their vehicle in the parking area using a wireless vehicle entry device at the same time that the user was looking for his/her vehicle, resulting in an arming acknowledgement signal being provided by more than one vehicle at the same time. Since the vehicle arming signal from the user has been recorded by recording unit 464, the user's vehicle arming signal can be rebroadcast as many times as necessary until the user's vehicle is located with certainty, i.e., is the only vehicle detected to provide an arming acknowledgement signal.

According to a further exemplary embodiment, vehicle location station 430 can include camera 460 to identify the user. When the user reaches his/her vehicle after it has been located, a verification mechanism can be provided to ensure that the person entering the vehicle is the same person who used the vehicle location station. The verification mechanism can be included in data processing unit 458, and verification can be achieved by comparing the user's image provided by camera 460 at vehicle location station 430, and images provided by one or more of cameras 472 of the arming acknowledgement signal detecting units 440 in the parking area. An alarm may be signaled if there is not a match.

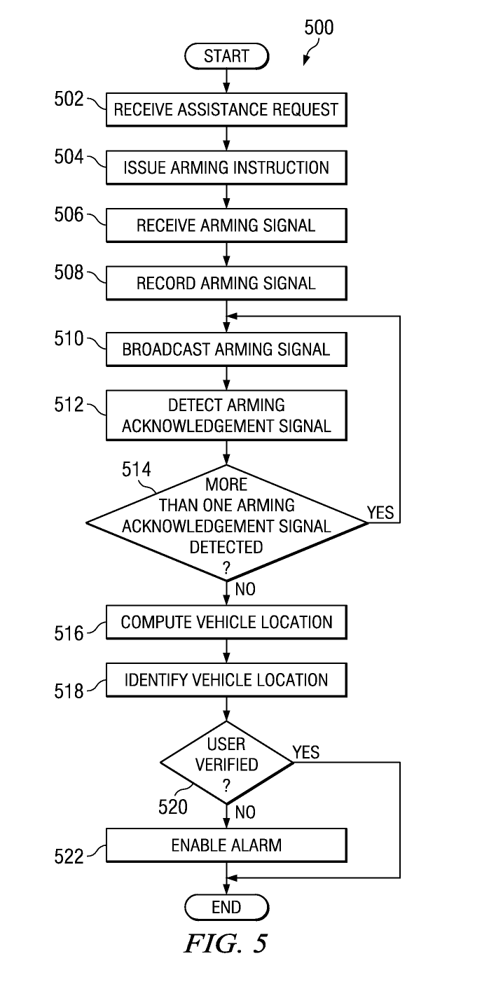

FIG. 5 is a flowchart that illustrates a method for locating a parked vehicle according to an exemplary embodiment. The method is generally designated by reference number 500, and begins by receiving a user request for assistance in locating a vehicle (Step 502). This can be done, for example, by a user pressing a “start” button on user input 468 at vehicle location station 430 in FIG. 4. The user is then instructed to lock his/her vehicle using his/her wireless vehicle entry device (Step 504). The vehicle arming signal generated by the user's device is received (Step 506) and recorded (Step 508). The recorded vehicle arming signal is then broadcast throughout a parking area (Step 510). For example, the vehicle arming signal may be broadcast by being transmitted over the parking area directly from transmission unit 466 at vehicle location station 430, or it may be transmitted to retransmission units 435 and then broadcast over the parking area by the retransmission units.

An arming acknowledgement signal provided by a vehicle that is armed by the broadcast vehicle arming signal is then detected (Step 512), for example, by one or more of arming acknowledgement signal detecting units 440 in FIG. 4. A determination is made if more than one arming acknowledgement signal is detected (Step 514), as might occur if a different person is locking his/her vehicle using a wireless vehicle entry device at the same time that the vehicle arming signal from the user's wireless vehicle entry device is being broadcast. If only one arming acknowledgement signal is detected (No output of Step 514), the location of the vehicle is computed (Step 516), and the vehicle location is identified to the user (Step 518). If more than one arming acknowledgement signal is detected (Yes output of Step 514), the method returns to Step 510 to again broadcast the vehicle arming signal.

When an individual enters the located vehicle after the location has been identified to the user, a determination can optionally be made if the individual is the same person as the user (Step 520). If the individual is the same person (Yes output of Step 520), the method ends. If the individual is not the same person as the user (No output of Step 520), an alarm is enabled (Step 522) and the method ends.

Exemplary embodiments thus provide a method and system for locating a parked vehicle. A method for locating a parked vehicle according to an exemplary embodiment includes receiving a vehicle arming signal at a vehicle arming signal receiving unit. The received vehicle arming signal is broadcast throughout a parking area in which a vehicle associated with the vehicle arming signal is parked. An arming acknowledgement signal provided by the vehicle associated with the vehicle arming signal is detected, and a location of the vehicle associated with the vehicle arming signal is identified using the arming acknowledgement signal.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for locating a parked vehicle, comprising:
receiving a vehicle arming signal at a vehicle arming signal receiving unit;
broadcasting the received vehicle arming signal throughout a parking area in which a vehicle associated with the vehicle arming signal is parked;
detecting an arming acknowledgement signal provided by the vehicle associated with the vehicle arming signal; and
identifying a location of the vehicle associated with the vehicle arming signal using the arming acknowledgement signal.

2. The method of claim 1, wherein the vehicle arming signal is generated by a wireless vehicle entry device within a vicinity of the vehicle arming signal receiving unit.

3. The method of claim 1, wherein broadcasting the received vehicle arming signal throughout a parking area in which a vehicle associated with the vehicle arming signal is parked, comprises:
transmitting the received vehicle arming signal to a plurality of vehicle arming signal retransmission units in the parking area; and
broadcasting the received vehicle arming signal from each of the plurality of vehicle arming signal retransmission units.

4. The method of claim 1, wherein detecting an arming acknowledgement signal provided by the vehicle associated with the vehicle arming signal, comprises:
detecting the arming acknowledgement signal provided by the vehicle associated with the vehicle arming signal at a plurality of locations around the parking area.

5. The method of claim 4, wherein the arming acknowledgement signal comprises at least one of flashing headlights and an operation of a vehicle horn, and wherein detecting the arming acknowledgement signal provided by the vehicle associated with the vehicle arming signal at a plurality of locations around the parking area comprises:
detecting at least one of the flashing headlights and the operation of a vehicle horn at the plurality of locations around the parking area.

6. The method of claim 1, wherein identifying the location of the vehicle associated with the vehicle arming signal using the arming acknowledgement signal, comprises:
computing the location of the vehicle associated with the vehicle arming signal using the arming acknowledgement signal; and
identifying the computed location of the vehicle associated with the vehicle arming signal to a user on a display.

7. The method of claim 6, wherein computing the location of the vehicle associated with the vehicle arming signal using the arming acknowledgement signal, comprises:
computing the location of the vehicle associated with the vehicle arming signal using a triangulation algorithm.

8. The method of claim 1, and further comprising:
verifying an identity of an individual entering the located vehicle associated with the vehicle arming signal.

9. The method of claim 1, and further comprising:
determining whether more than one arming acknowledgement signal is detected in the detecting step; and
repeating the broadcasting step if more than one arming acknowledgement signal is detected in the detecting step.

10. A vehicle locating system, comprising:
a vehicle arming signal receiving unit for receiving a vehicle arming signal;
a broadcasting unit for broadcasting the received vehicle arming signal over a parking area in which a vehicle associated with the vehicle arming signal is parked;
at least one detecting unit for detecting an arming acknowledgement signal provided by the vehicle associated with the vehicle arming signal; and
a vehicle location identification unit for identifying a location of the vehicle associated with the vehicle arming signal using the arming acknowledgment signal.

11. The vehicle locating system of claim 10, wherein the vehicle arming signal is generated by a wireless vehicle entry device in a vicinity of the vehicle arming signal receiving unit.

12. The vehicle locating system of claim 10, wherein the vehicle arming signal receiving unit is at a vehicle location station, and wherein the broadcasting unit comprises:
a transmitting unit at the vehicle location station for transmitting the received vehicle arming signal; and
a plurality of vehicle arming signal retransmission units in the parking area for receiving the vehicle arming signal transmitted by the transmitting unit and for broadcasting the received vehicle arming signal over the parking area.

13. The vehicle locating system of claim 12, and further comprising a recording unit at the vehicle location station for recording the received vehicle arming signal.

14. The vehicle locating system of claim 10, wherein the at least one detecting unit comprises a plurality of detecting units in the parking area.

15. The vehicle locating system of claim 10, wherein the arming acknowledgement signal comprises at least one of flashing headlights and an operation of a vehicle horn, and wherein each of the plurality of detecting units comprises at least one of an image arming acknowledgement signal detecting unit for detecting the flashing headlights, and a sound arming acknowledgement signal detecting unit for detecting the operation of the vehicle horn.

16. The vehicle locating system of claim 10, wherein the vehicle location identification unit comprises:
a processing unit for computing the location of the vehicle associated with the vehicle arming signal using the vehicle acknowledgement signal; and
a display for identifying the computed location of the vehicle associated with the vehicle arming signal to a user.

17. The vehicle locating system of claim 10, and further comprising:
a verification unit for verifying an identity of an individual entering the located vehicle associated with the vehicle arming signal.

18. A vehicle locating system, comprising:
a vehicle location station, the vehicle location station comprising:
a vehicle arming signal receiving unit for receiving a vehicle arming signal generated by a wireless vehicle entry device of a user in a vicinity of the vehicle arming signal receiving unit;
a transmitting unit for transmitting the received vehicle arming signal; and
a vehicle location identification unit for identifying a location of a vehicle associated with the vehicle arming signal to the user;
a plurality of vehicle arming signal retransmission units in a parking area for receiving the vehicle arming signal transmitted by the transmitting unit and for broadcasting the received vehicle arming signal over the parking area; and
a plurality of detecting units in the parking area for detecting an arming acknowledgement signal provided by the vehicle associated with the vehicle arming signal, wherein the vehicle location identification unit identifies the location of the vehicle associated with the vehicle arming signal to the user at the vehicle location station using the arming acknowledgment signal.

19. The vehicle locating system of claim 18, wherein the arming acknowledgement signal comprises at least one of flashing headlights and an operation of a vehicle horn, and wherein each of the plurality of detecting units comprises at least one of an image arming acknowledgement signal detecting unit for detecting the flashing headlights and a sound arming acknowledgement signal detecting unit for detecting the operation of the vehicle horn.

20. The vehicle locating system of claim 18, wherein the vehicle location identification unit comprises:
a processing unit for computing the location of the vehicle associated with the vehicle arming signal using the arming acknowledgement signal; and
a display for identifying the computed location of the vehicle associated with the vehicle arming signal to the user.
